(19) United States
(12) Patent Application Publication
(10) Pub. No.: US 2004/0082418 A1
(43) Pub. Date: Apr. 29, 2004

(54) Power branched transmission

(76) Inventors: Jurgen Wafzig, Eriskirch (DE); Gerhard Gumpoltsberger, Friedrichshafen (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/665,048

(22) Filed: Sep. 17, 2003

(30) Foreign Application Priority Data
Oct. 24, 2002 (DE) 102 49 487.8

(51) Int. Cl. F16H 47/04

(52) U.S. Cl. 475/31

(57) ABSTRACT

A power branched transmission is proposed, including a frictional wheel variator and two planetary gears, whereby the frictional wheel variator (1), the first planetary gear (2) and the second planetary gear (3) are all positioned coaxially and behind each other in the direction of power flow.

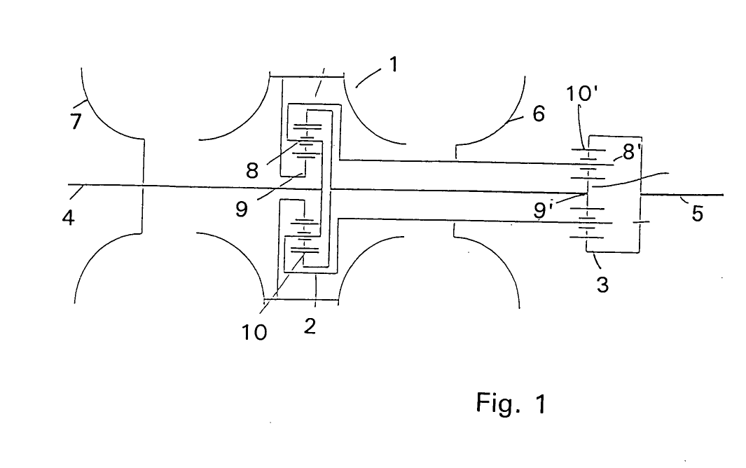

This invention is based on a power branched transmission that includes a frictional wheel variator according to the main concept of patent claim 1.

Continuously variable frictional wheel variators that manifest at least two torus discs with toroid-shaped running surfaces between which rolling bodies roll are known from the current state of the technology. Such frictional wheel variators manifest, in addition to a continuous translating change, a high turning moment capacity.

From DE 196 29 213 A1, a transmission is known that can operate in two power ranges. The basic component parts of this known frictional wheel transmission are a continuously variable frictional wheel variator with pairs of interacting toroid-shaped running surfaces, a countershaft, as well as an accumulation gear. In the process, a power branch is planned in the lower range (Low). The power movement is sent from the motor shaft across a translating stage to the countershaft and then to the continuously variable gear (frictional wheel variator) that is connected on the power side to the accumulation gear. By means of a second power branch, the movement power is sent directly from the countershaft and a translating stage to the accumulation gear where the power of both power branches is added up and sent to the driven shaft.

In the second power range (HIGH) of this known transmission, the power movement is sent across a translating stage to a countershaft and finally to the continuously variable gear. Another power portion is not envisioned in this case.

From DE 197 03 544 A1 another transmission is known in which a power branching is provided and a continuously variable gear, especially a gear with a pair of interacting toroid-shaped running surfaces (frictional wheel gears), is used. This known transmission also manifests an interim or countershaft in order to make the desired power branching possible. In the transmission according to DE 197 03 544 A1, the power in the first power range is sent from the motor shaft across a frictional wheel variator to the driven shaft, whereby the planetary gears rotate as a unit; in the second power range, the power is, on the one hand, sent across a frictional wheel variator to the planetary gear and, on the other hand, directly to the planetary gears whereby the power from the planetary gears is added up and sent to the driven shaft.

For power branching by means of a side shaft, as envisioned according to the state of technology, much construction space today is needed that is required for other power train components. In addition, such a conception is only suited, to a limited degree, for a front longitudinal assembly.

This invention thus has the goal, after starting from the state of the technology, of providing a transmission that combines the comfort advantages of continuous gears with a low requirement for construction space and low manufacturing and maintenance costs. In addition, the transmission of the invention should not include any shifting elements.

The goal is achieved by means of the characteristics of patent claim 1. Other execution models and advantages can be seen in the sub-claims.

Accordingly, a power branched transmission is proposed that includes a frictional wheel variator, a first planetary gear and a second planetary gear, whereby the frictional wheel variator and the planetary gears are positioned in a coaxial manner and the power conveyed by the frictional wheel variator is conveyed across the first planetary gear and coaxially through the frictional wheel variator to the second planetary gear that is connected to the driven shaft.

By means of this construction, no side shaft is necessary whereby a compact manner of construction results.

In the context of a favored execution model, the transmission of the invention makes possible engine rotations at engine standstill and accordingly manifests a geared-neutral characteristic. This means that very high moments are available for starting so that no starting elements are needed.

Because of the geared-neutral structure, shifting elements are advantageously not required. In addition, the transmission manifests a permanent power branching.

In the following section the invention will be explained in more detail based on a drawing that depicts a preferred execution model.

According to the FIGURE, the transmission of the invention includes a frictional wheel variator 1, two planetary gears 2, 3, a motor shaft 4, and a driven shaft 5.

The outer torus discs 6, 7 of the frictional wheel variator 1 are supplied with the motor revolutions; that occurs directly on torus disc 6 and for the second torus disc 7 by means of an element of the first planetary gear 2, preferably by means of a flange 8 of the first planetary gear 2 that is positioned between the disc pair of the frictional wheel variator and coaxial with it. In addition, the motor shaft 4 preferably is connected by means of a flange 8 of the first planetary gear 2 with an element of the second planetary gear 3, preferably with the flange 8′.

The output power of the frictional wheel variator 1 is sent, according to the invention to an element of the first planetary gear 2, here to the sun wheel 9; then the power movement that was provided with a translation of the first planetary gear 2 across another element, in the context of the execution model depicted here, across the ring gear 10 of the first planetary gear 2, is sent by means of the second disc pair of the frictional wheel variator (viewed in the direction of power flow) to an element, preferably to the sun wheel 9′ of the second planetary gear 3. In the second planetary gear 3, the drive component from the frictional wheel variator 1 and the direct drive component from the motor revolution, that is sent to flange 8′ as already described in the figure, are added up and are sent across another element of the second planetary gear, preferably across its ring gear 10′, to the driven shaft 5.

Because of the geared-neutral structure, the need for shifting elements was eliminated since the determination of the direction of rotation of the driven shaft 5 occurs by means of a suitable variator translation. When the variator translation is greater than a certain value, there is then a negative total gear translation and a reverse gear occurs.

A typical value for the spread of the frictional wheel variator is 5, whereby an advantageous value for the initial translation of the first planetary gear 2 is about −1.8 and for the second planetary gear 3 about −1.7. The transmission of the invention represents a very high gear spread at the above initial gear translations. Other values are possible, however, depending on the design of the transmission.

A reverse gear with a translation of −17.00 is possible with these values as well as any high forward gear.

The gear system thus manifests a very high spread with minimal construction effort since no range couplings are necessary. Because of the conception of the invention, as previously explained, very high start translations can be attained so that no start element is needed.

In the context of another execution model, a single-duct frictional wheel variator can be used in order to achieve even a more compact construction.

According to the invention, a shifting element can be placed at any desired location in order to avoid control irregularities, or for safety reasons, in the event that is necessary.

### REFERENCE NUMBERS

| | |
|---|---|
| 1 | Frictional wheel variator |
| 2 | First planetary gear |
| 3 | Second planetary gear |
| 4 | Motor shaft |
| 5 | Driven shaft |
| 6 | Outer torus disc |
| 7 | Outer torus disc |
| 8 | Flange |
| 8′ | Flange |
| 9 | Sun wheel |
| 9′ | Sun wheel |
| 10 | Ring gear |
| 10′ | Ring gear |

1. Power branched transmission including a frictional wheel variator and two planetary gears characterized in that the frictional wheel variator (1), the first planetary gear (2) and the second planetary gear (3) being coaxially positioned and behind each other in the power flow direction.

2. Power branched transmission according to claim 1, characterized in that the power conveyed in the frictional wheel variator (1) being sent coaxially across the first planetary gear (2) by means of the frictional wheel variator (1) to the second planetary gear (3) that is connected to the driven shaft (5).

3. Power branched transmission according to one of the previous claims, characterized in that the first planetary gear (2) being placed between the disc pair of the frictional wheel variator (1).

4. Power branched transmission according to one of the previous claims, characterized in that the outer torus discs (6,7) of the frictional wheel variator (1) being impacted with the motor revolutions, whereby one outer torus disc (6) is connected directly and the second torus disc (7) by means of a flange (8) of the first planetary gear (2) with the motor shaft (4) and whereby the motor shaft (4) is connected across the flange (8) of the first planetary gear (2) with the flange (8′) of the second planetary gear (3).

5. Power branched transmission according to one of the previous claims, characterized in that the output power of the frictional wheel variator (1) being conveyed to the sun wheel (9) of the first planetary gear (2), where it is sent across the hollow wheel (10) of the first planetary gear (2) by means of the second disc pair of the frictional wheel variator (1), as viewed in the direction of power flow, to the sun wheel (9′) of the second planetary gear (3) and by the components of the frictional wheel variator (1) in the second planetary gear (3) and the direct portion of the motor revolutions being added and being sent across its hollow wheel (10′) to the driven shaft (5).

6. Power branched transmission according to one of the previous claims, characterized in that its manifesting a geared-neutral characteristic, so that no shifting elements are envisioned.
